(19) United States
(12) Patent Application Publication
(10) Pub. No.: US 2014/0356639 A1
(43) Pub. Date: Dec. 4, 2014

(54) METHOD FOR INCREASING THE RESISTANCE OF A BLUED LAYER, AND COMPONENT HAVING A BLUED LAYER WITH INCREASED RESISTANCE

(71) Applicants: Jürgen Gegner, Forchheim (DE); Matthias Mallak, Gochsheim (DE); Wolfgang Nierlich, Schweinfurt (DE)

(72) Inventors: Jürgen Gegner, Forchheim (DE); Matthias Mallak, Gochsheim (DE); Wolfgang Nierlich, Schweinfurt (DE)

(21) Appl. No.: 14/238,141

(22) PCT Filed: Aug. 10, 2012
(86) PCT No.: PCT/EP2012/065707

§ 371 Date: Aug. 21, 2014

(30) Foreign Application Priority Data
Aug. 10, 2011 (DE) 10 2011 080 750.0

(51) Int. Cl. B05D 3/10; B05D 3/12; F16C 33/30; B05D 1/18

(52) U.S. Cl. CPC B05D 3/102; B05D 1/18; B05D 3/12; F16C 33/30
USPC 428/469; 427/430.1; 427/299

(57) ABSTRACT

A method for increasing the resistance of a blued layer of a component includes partially or completely immersing a component having the blued layer into a solution containing potassium dichromate. An increase of the resistance of the blued layer of the component to chemical corrosion and/or mechanical loads results therefrom.

Exemplary embodiments relate to a method for increasing the resistance of a blued layer and to a component having a blued layer, for example a component of a highly-loaded machine, such as a wind turbine.

The process of bluing and the blued layers resulting therefrom are used in wide areas of the machine-, systems-, and tool arts, as well as other technical fields, for different reasons. In addition to a relatively simple and economical possibility to completely or partially change a component in color, such as bluing is used for example in the field of weapons technology, blued layers or blued components have improved resistance to tribological and/or chemical attacks as compared to untreated components. Blued layers thus often have an improved bending- or abrasion-resistance and can be heat-resistant up to temperatures of more than 200° C. Not least for these reasons, blued components and blued layers are used in the machine-, systems-, and tool arts.

However, blued layers and blued components have only a limited resistance with respect to tribological, tribo-chemical, and chemical attacks during the operation of a machine to which the component in question belongs. Corresponding attacks can be caused, for example, by acids, which can be present when a lubricant ages or also when a lubricant is contaminated. But the blued components or their blued layers also only counter tribological-mechanical and combined loads to a limited degree.

An increase of the resistance with respect to such attacks is conventionally achieved by an increase of the layer thickness of the blued layer or by a multiple-bath bluing according to DIN standard 50 938. However, these methods are limited with respect to their technical as well as their economic implementation. The increase of the resistance of the blued layer in question is limited.

There is therefore a need to increase a resilience or a resistance of a blued layer of a component.

An exemplary embodiment of a method for increasing the resistance of a blued layer of a component according to patent claim 1, a component having a blued layer according to an exemplary embodiment according to patent claim 9, or a component having a blued layer according to an exemplary embodiment according to patent claim 10 addresses this need.

An exemplary embodiment of a method for increasing the resistance of a blued layer of a component comprises providing the component having the blued layer, and a complete or partial immersion of the component having the blued layer into a solution which comprises potassium dichromate. With partial immersion, the component can be moved in the solution which comprises potassium dichromate such that the entire blued layer is treated.

An exemplary embodiment of a component having a blued layer can thus be manufactured or treated using a method according to an exemplary embodiment.

A component having a blued layer according to an exemplary embodiment is manufactured from a material which includes iron, wherein the blued layer lies at least partially open and has no oiling. In other words, the blued layer is free of oiling. The blued layer includes residues of a potassium dichromate solution and/or reaction products of a potassium dichromate solution with the material or the blued layer of the component.

Exemplary embodiments are thus based on the recognition that the resilience or resistance of a blued layer of a component can be increased by immersing it in a potassium dichromate solution. By utilizing an exemplary embodiment, the resistance of the blued layer to acid attack can thus be significantly increased. There is also the prospect that a corresponding success with tribological-mechanical loads is also achievable.

In an exemplary embodiment of a method, the solution has a temperature which falls between 15° C. and 100° C., in particular between 70° C. and 90° C. Thus temperatures in the range of room temperature and the aforementioned elevated temperatures have yielded remarkable results, wherein for example a sample which has been immersed at a temperature of approximately 80° C. according to an exemplary embodiment of the method has shown a very good result, in that the resistance to oxalic acid is noticeably increased. In particular in the range of temperatures between 75° C. and 85° C., a technologically highly exploitable increase of the resistance can be achieved, while the energy requirement is reducible for heating of the solution and of the component.

In an exemplary embodiment of a method for increasing the resistance of a blued layer, the component can be immersed in the solution for a period of time (immersion duration) which falls between 5 minutes and 120 minutes, in particular between 10 minutes and 75 minutes. Experiments have thus shown, for example, that in particular at temperatures of the solution between 70° C. and 90° C. or between 75° C. and 85° C., even with a process duration between 10 minutes and 20 minutes, a significant increase of the resistance of the blued layer is achievable. In other words, the throughput of the method can thus be optionally increased by raising the temperature of the solution due to a possible shortening of the period of time for immersing the component in the solution.

In an exemplary embodiment of the method, the solution can be an aqueous solution. Thus potassium dichromate has a good solubility in water, while it is nearly insoluble in other solvents.

In such an exemplary embodiment, the solution can thus comprise between 10 g/l and 150 g/l potassium dichromate. Depending on the temperature of the solution, there can thus be a different solubility (e.g. of approximately 120 g/l at 20° C.). This optionally makes it possible to find a compromise between the use of the amount of potassium dichromate on the one hand and the method duration on the other hand, which in turn is not least co-determined by the aforementioned period of time (immersion duration) for the immersion of the component into the solution. The compromise can be oriented to the particular requirements of a particular implementation of an exemplary embodiment of the method, and optionally even optimized to the boundary conditions.

If the component has previously been preserved, an exemplary embodiment of a method can further include removing a preservative from the component prior to the immersing into the solution. Likewise, an exemplary embodiment can additionally or alternatively include a degreasing and/or a cleaning of the component prior to the immersing in the solution. In this way the contact of the solution with the component or the blued layer can optionally be improved, which in turn can advantageously affect the aforementioned period of time. In other words, in this way a spatial separation of solution and blued layer can optionally be eliminated or reduced.

In an exemplary embodiment of a method wherein the component is only partially immersed in the solution, the partial immersing of the component can include moving the component such that at least a section of the blued layer is treated by the solution, which section would not be treated without the movement. In an exemplary embodiment, the blued layer can thus be completely immersed in the solution. Using an exemplary embodiment, it can in this way be possible to treat even components which are larger than a bath or vessel that holds the solution. The moving of the component can thus for example include a rotation and/or a method thereof. It can also include moving the component out of the bath. In this case the moving can occur continuously or at least include a time period in which the component is unmoved.

An exemplary embodiment of a method can further include, after the immersing of the component into the solution, rinsing the component and/or drying thereof after the immersing of the component into the solution.

In an exemplary embodiment of a method, the providing of the component can comprise providing the component, which is manufactured from a material that comprises iron, in particular steel, for example a rolling-element bearing steel.

Exemplary embodiments in the form of components having a blued layer are based herein on the recognition that, by using an exemplary embodiment of a method for increasing the resistance of the blued layer, a further post-processing of the blued layer can optionally be omitted, so that it lies at least partially open and for example is free of oiling, i.e. has no oiling. In this way, manufacturing of the component, integration of the component into a more complex subassembly or a machine can optionally be simplified and/or operation of such a machine can be advantageously influenced. An additional post-processing of the blued layer can thus optionally be omitted, wherein a lubricating agent, a lubricant, a grease, an oil, or another medium, which then must be removed prior to the integration into the subassembly or the machine, optionally remains behind on the blued layer. Likewise, resupplying the material in question during the operation of the subassembly or of the machine can optionally be reduced or completely omitted.

Exemplary embodiments will be explained below with reference to the accompanying Figures.

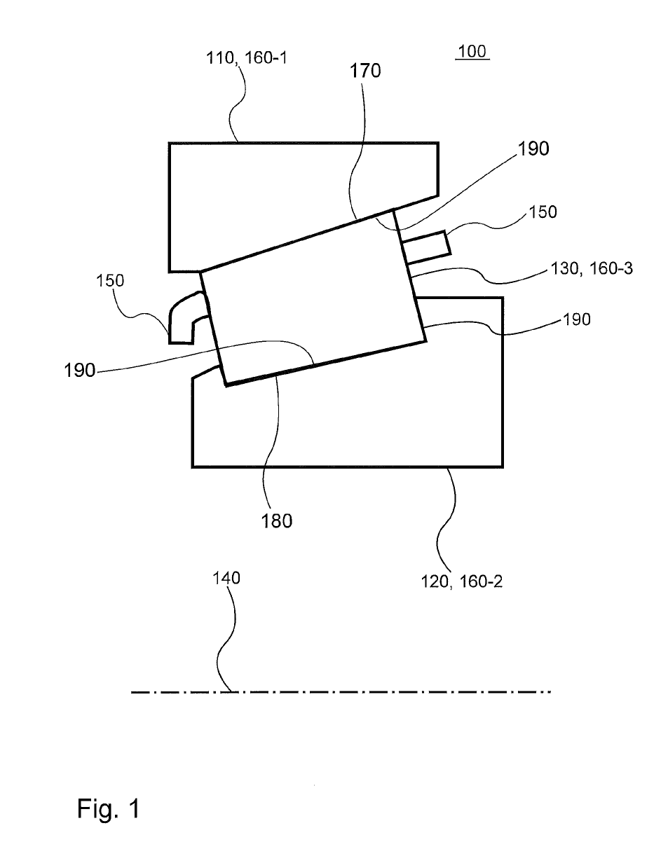

FIG. 1 shows a schematic cross-sectional view though a cylindrical roller bearing including a plurality of components which can be embodied according to an exemplary embodiment; and

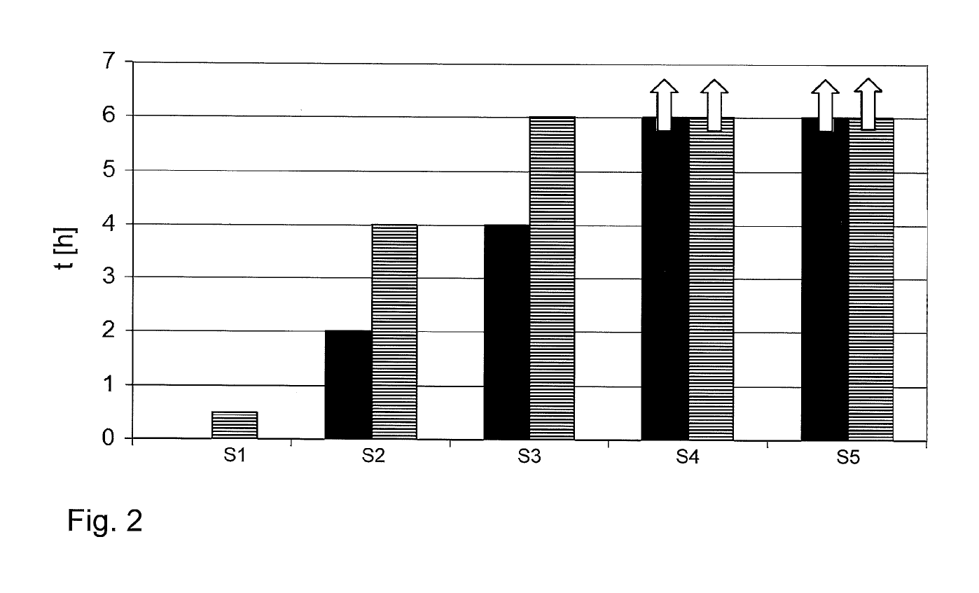

FIG. 2 illustrates an increase of the resistance of a blued layer of a plurality of samples against the action of a ten-percent oxalic acid. An oxalic acid test is part of the quality control of blued layers according to DIN standard 50938.

In the context of the present description, summarizing reference numbers are used for objects, structures, and other components if the relevant component is described with respect to itself or a plurality of corresponding components within an exemplary embodiment or within a plurality of exemplary embodiments. Passages of the description which refer to a component are therefore transferable to other components in other exemplary embodiments, insofar as this is not explicitly excluded or this follows from the context. If individual components are referred to, individual reference numbers are used which are based on the corresponding summarizing reference numbers. In the following description of embodiments, like reference numbers refer to like or comparable components. Components which occur multiple times in an exemplary embodiment or in different exemplary embodiments can thereby be embodied or implemented identically and/or differently with respect to some of their technical parameters. It is thus for example possible that a plurality of entities can be implemented identically within an exemplary embodiment with respect to one parameter, but differently with respect to another parameter.

FIG. 1 shows a cylindrical roller bearing 100 having an outer ring 110, an inner ring 120, and a plurality of cylindrical rolling elements, of which, for simplification of the illustration in FIG. 1, only one rolling element 130 is illustrated. FIG. 1 shows here a half of the cross-section through the cylindrical roller bearing 100, which half is located above a line of symmetry 140. However, the cylindrical roller bearing 100 is embodied substantially rotationally-symmetric with respect to the line of symmetry 140. The rolling elements 130 are retained and guided by a rolling-element cage 150.

The outer ring 110, the inner ring 120, and the rolling elements 130 can each optionally be embodied according to an exemplary embodiment as components 160-1, 160-2, 160-3. Thus, they can blued for example at least in one region in which they are respectively in contact with another component, i.e. have a blued layer.

In the case of the outer ring 110 as component 160-1, it can thus include a corresponding blued layer at least in the region of its raceway 170. The same can also apply for the inner ring 120 (component 160-2) in the region of its raceway 180, as well as for the rolling elements 130 (components 160-3) in the region of their contact surfaces 190, with which they are in contact with the outer ring 110 and the inner ring 120 during the operation of the cylindrical roller bearing 100, i.e. roll on these. In the ideal case, it is a rolling contact, which however cannot be ensured under all operating conditions in all machines or subassemblies into which the cylindrical roller bearing 100 can be integrated.

The outer ring 110, the inner ring 120, and/or the rolling elements 130, in so far as these are embodied as components 160 according to exemplary embodiments or have been post-treated using a method according to an exemplary embodiment, can thus for example be manufactured from a steel, in particular from a rolling-element bearing steel, but also from another ferrous material. They are then blued at least in the aforementioned regions, wherein here possibly-existing other regions of the component 160 in question have been covered with a suitable masking layer.

A variety of different bluing techniques and bluing methods are available for carrying out the bluing, even if chemical hot bluing is typically used nowadays. Here the components 160 to be blued are treated in an immersion method, wherein the iron in the component is converted in a chemical reaction into iron oxide (into FeO/Fe₂O₃ mixed oxide or Fe₃O₄ (magnetite)). The blued layers thus represent conversion layers, i.e. they substantially represent a non-metallic, inorganic layer on the metal surface of the component in question. The layer thicknesses of the respective blued layers can be controlled here by the manner of performing the method, but also by process parameters. These include, among others, the immersion duration, but likewise also the composition of the bluing bath.

Typical layer thicknesses thus fall in the range of a few 100 nm, i.e. in the range between approximately 0.2 μm and approximately 1 μm. However, blued layers can also be manufactured having thicknesses of up to 2.5 μm. With blued components according to exemplary embodiments, a thinner layer thickness of the particular blued layer can often be selected, since they experience an increase with respect to their resistance due to the post-treatment. Thus blued layers having a thickness of at most 1.5 μm, at most 1.0 μm, at most 800 nm, or at most 500 μm can typically suffice in many applications.

With hot bluing, the components 160 in question are immersed, in a one- or multiple-step method, into an alkaline salt solution having a temperature in the range from approximately 135° C. to 145° C., as is defined for example in the DIN standard DIN 50938:2000. The iron (Fe) of the surface of the component is thereby converted into the aforementioned oxides, in particular into magnetite (Fe₃O4), which is also referred to as black oxide of iron. In this case, magnetite has an approximately comparable volume to metallic iron. The bluing bath can be formed based on potassium nitrite (KNO₃) and sodium hydroxide (NaOH), but also based on other chemical compositions.

In hot bluing, one-bath, two-bath, and three-bath bluing methods can thus be used, wherein the treated components are often intermediately rinsed in water and the bath temperatures are each successively raised by approximately 5° C. Specific properties of the blued layer can be adjusted by this controlling of the reaction kinetics. In hot bluing, the immersion times in the bluing bath typically lie between approximately 5 minutes and approximately 20 minutes per bath and are only dependent on the composition of the components and the concentrations and temperatures of the bluing bath.

In addition, however, components can also be at least partially coated with a corresponding blued layer by using other methods, such as with so-called cold bluing.

The use of an exemplary embodiment of a method for increasing the resistance of a blued layer of a component 160, for example of the outer ring 110, of the inner ring 120, or of one or more rolling elements 130, thus makes it possible to improve the limited resistance of the blued layers with respect to tribological and/or chemical attacks during the operation of the machine that will later include the component in question. Chemical attacks can take place for example by acids which result from the aging of lubricant or from a contamination of lubricants.

Moreover, the use of an exemplary embodiment of a method can also optionally increase an improvement of the resistance with respect to tribological-mechanical and/or combined loads. For example, an exemplary embodiment of a method can optionally be advantageously used with components 160 if, for example, mixed friction is present in the rolling contact, which mixed friction can lead to a greater tribological-mechanical load.

Thus, for example, under high material loading in the mixed-friction region a cyclical elastic-plastic deformation can form in regions near the surface, which elastic-plastic deformation is accompanied by micro-crack formation. This fatigue wear phenomenon known as “micropitting,” which follows the mechanism of the corrosion fatigue as corrosion rolling fatigue, can lead in certain circumstances to deeper cracks, and subsequently to large-area eruptions in the component 160 in question, or produce extensive surface material separation. Micropitting can occur for example when, in a highly-loaded contact of two components, possibly high slippage speeds and/or a low lubricant thickness are present. This can thus for example be promoted or caused by a high load, low rotational speed, high lubricant temperatures, unfavorable geometries, unfavorable surface conditions, or other unfavorable lubricant properties.

Exemplary embodiments now make it possible to optionally improve the limited resistance of blued layers with respect to the aforementioned loads in that the blued layers or the blued components 160 are chemically post-treated. In this case, the innovation consists of the carrying out of a chemical post-treatment of blued components 160 in a potassium dichromate solution (K₂Cr₂O₇) at temperatures between approximately 15° C. and approximately 100° C., i.e., for example, at room temperature or preferably at an elevated temperature, wherein a temperature of approximately 80° C. (e.g. a temperature between 75° C. and 85° C.) has shown a very good result in the field of the resistance to chemical attacks. By using a method according to an exemplary embodiment, the resistance of the blued layer can thus be significantly increased, for example to acid attack.

However, also with respect to the above-described tribological-mechanical loads there is the prospect that a corresponding success, such as in the case of the above-described mixed friction in the rolling contact and the micropitting possibly resulting therefrom, is achievable. To this end experiments have been carried out on test stands.

In this post-treatment method according to an exemplary embodiment, not-preserved components 160 are introduced after the bluing into a potassium dichromate solution (K₂Cr₂O₇) solution for, for example, 15 minutes to 60 minutes. If the components 160 have already been intermediately preserved, it can in this case be advisable to remove the preservative beforehand with a solvent, a solvent mixture, or another substance, mixture of substances, or another method. Even in the case of not-preserved components 160, it can also optionally be advisable to perform a degreasing and/or another cleaning of the relevant component prior to the immersing in the potassium dichromate solution.

The solution into which the the component is immersed following a providing thereof with the bluing layer, comprises, as was previously explained, potassium dichromate. In addition to the aforementioned temperatures (room temperature and approximately 80° C.), in other exemplary embodiments of the method the solution can also have other temperatures, which for example fall in the range between approximately 15° C. and approximately 100° C. In particular, the solution can also have a temperature between 70° C. and 90° C. or between 75° C. and 85° C. Depending on the temperature, desired increase of the resistance, and other technical and economic boundary conditions, the component 160 in question can be immersed in the solution for a period of time (immersion duration) which typically falls between 5 minutes and 90 minutes, in particular between 10 minutes and 70 minutes. Here shorter periods of time can optionally be realized if higher temperatures of the solution are used.

The solution is typically implemented as an aqueous solution, since potassium dichromate has a good solubility in water. The solution can thus comprise for example between 10 g/l and 150 g/l potassium dichromate. Here it should be noted that the solubility can be temperature-dependent, so that at higher temperatures, higher solubilities and thus higher concentrations are optionally achievable.

In the case of larger components, it can optionally be expedient to only partially immerse them into the solution. Smaller baths or vessels for the treatment according to an exemplary embodiment can thereby be used, which in addition to a reduction of logistical challenges can also be advisable in view of possible hazards due to the ingredients of the solution. In order to nevertheless make possible a sufficient contact of the blued layer of the component 160 with the solution, it is expedient to move the component during the immersion in the solution. This can be effected for example by machine, for example via an industrial robot, with smaller components optionally also “by hand” using appropriate (protective) tools.

Here the movement can for example comprise a turning or rotation, however also a translational movement of the component. Depending on the specific implementation of the method according to an exemplary embodiment, the movement can be effected continuously or include at least one period of time wherein the component is unmoved. Thus for example the component can be immersed into the solution for the envisaged immersion time with a first section of the blued layer, which for example comprises more than half of this blued layer, before the component is turned or moved such that a second section, which comprises at least the hitherto-untreated region of the blued layer, is immersed into the bath again for the envisaged immersion duration or even a different period of time. Alternatively or additionally, the component can also be continuously turned in the bath, provided that all sections to be treated remain in the solution at least for the immersion duration intended for them.

Thus, for example, components can be treated in a bath, the height of which bath does not exceed that of the component. If a single turning is provided, and if the entire component is to be treated, it can be advisable that the height of the solution with the component immersed be dimensioned such that this height is higher than half of the component. Thus while a central region of the component is possibly treated more than once, all sections of the component are however immersed into the bath at least for their corresponding immersion duration.

After the immersion in the solution, the component can be cleaned by rinsing in water or another solution. This rinsing treatment can occur at room temperature or even at higher temperatures, for example between 30° C. and 80° C. Additionally or alternatively, drying of the component 160 can also occur, for example by drying the component 160 in an oven or using hot air. In this case, temperatures of more than 100° C. can be used to optionally accelerate the drying. Of course, however, lower temperatures, such as room temperature, can be used.

Even though an outer ring 110, an inner ring 120, and the rolling elements 130 have previously been described as possible components 160 in the context of FIG. 1, in principle all components which are blued and for example can be subjected to a chemical, tribo-chemical, or tribological attack during operation and/or their storage can be improved with respect to their resistance by using an exemplary embodiment of a method. These components thus also include other embodiments of rolling-element bearings, rolling-element bearing components (e.g. also cages), gears, and other mechanical components, but also other components such as subassemblies or machines corresponding to housings.

According to an exemplary embodiment, components 160 find application for example in the field of highly-loaded and/or large machines and systems, which also include, in addition to wind turbines, in which numerous rolling-element bearing components are often blued, underwater turbines, construction equipment, power plants, industrial transmissions of all types, and other machines and systems.

The quality of a blued layer is examined according to DIN standard 50938, among other ways, by the determination of the degree of protection using oxalic acid (C₂H₂O₄). Based on this test, after an effect of a ten-percent oxalic acid (C₂H₂O₄) at room temperature on the blued layer, significant differences appear between various samples, which were treated using exemplary embodiments of a method for increasing the resistance of a blued layer of a component, and those which were not treated using a method according to an exemplary embodiment.

Thus, for five different samples S1, S2, S3, S4, S5, FIG. 2 shows, with the exception of sample S1 (no chemical post-treatment according to an exemplary embodiment) a plotting of a time duration t in hours, after which an incipient attack was noticeable (solid bars) and after which a complete separation of the layer had occurred (hatched bars). These times are also referred to as resistance time. Only for the comparison sample S1, wherein a post-treatment using a method according to an exemplary embodiment was not carried out, is the period of time after which an incipient attack was noticeable not shown in FIG. 2, since it was noticeable immediately.

Without the chemical post-treatment according to an exemplary embodiment, under the influence of the oxalic acid the blued layer separates completely after only 30 minutes. An application of the new method according to an exemplary embodiment significantly improves this result, as FIG. 2 illustrates. Thus, with the treatment of a component (sample S2) using a potassium dichromate solution and an immersion time of 15 minutes at room temperature, the resistance to an attack is noticeable only at 2 hours. In this sample S2, the blued layer has completely separated only after 4 hours. In the case of the immersion of a component (sample S3) into the potassium dichromate solution for a time duration of 60 minutes at room temperature, the incipient attack is noticeable only after 4 hours, wherein the blued layer has completely separated only after 6 hours.

In the case of samples S4 and S5, which were each immersed into a potassium dichromate solution at 80° C., after 6 hours neither an incipient attack nor a complete separation of the layer was discernible. In other words, even after 6 hours the action of oxalic acid at room temperature on samples post-treated in an 80° C. hot potassium dichromate solution (samples S4 and S5), no chemical attack on the blued layer (layer) was visible. Samples S4 and S5 differ here only in that in the case of sample S4, it was immersed for 15 minutes in the potassium dichromate solution of 80° C., while sample S5 was immersed for 60 minutes in the potassium dichromate solution of 80° C.

Components 160 having a blued layer, which were post-treated using an exemplary embodiment in the form of a method, can in this case possibly have, in the region of the blued layer, residues of the potassium dichromate solution and/or reaction products of the potassium dichromate solution with the material of the component or of the blued layer of the component. These can possibly be detectable using a layer analysis. Thus in this case different chromium compounds, for example in the region of the blued layer, can optionally be detected.

The features disclosed in the above description, the claims, and the drawings can be meaningful for the realization of exemplary embodiments in their different designs, both individually and in any combination, and—insofar as nothing different results from the description—can be combined with one another in any way.

### REFERENCE NUMBER LIST

100 Cylindrical roller bearing
110 Outer ring
120 Inner ring
130 Rolling elements
140 Line of symmetry
150 Rolling-element cage
160 Component
170 Raceway
180 Raceway
190 Contact surface

1.-10. (canceled)

11. A method for increasing the resistance of a blued layer of a component, comprising:
completely or partially immersing the component having the blued layer into a solution containing potassium dichromate.

12. The method according to claim 11, wherein the solution is at a temperature of 15° C. to 100° C.

13. The method according to claim 12, wherein the temperature of the solution is 70° C. to 90° C.

14. The method according to claim 13, wherein the component is immersed in the solution for 5-120 minutes.

15. The method according to claim 14, wherein the component is immersed in the solution for 10-75 minutes.

16. The method according to claim 15, wherein the solution is an aqueous solution.

17. The method according to claim 16, wherein the solution comprises between 10 g/l and 150 g/l of the potassium dichromate.

18. The method according to claim 17, further comprising:
removing a preservative from the component prior to the immersion step, if the component; and/or
degreasing the component prior to the immersion step; and/or
cleaning the component prior to the immersion step.

19. The method according to claim 18, wherein the component is only partially immersed into the solution, and
the method further comprises:
moving the partially-immersed component in the solution such that at least a portion of the blued layer is treated by the solution, which portion would not be treated without the moving.

20. The method according to claim 19, wherein the component comprises steel.

21. The method according to claim 20, wherein the component comprises rolling-element bearing steel.

22. The method according to claim 11, wherein the component is immersed in the solution for 5-120 minutes.

23. The method according to claim 22, wherein the component is immersed in the solution for 10-75 minutes.

24. The method according to claim 11, wherein the solution is an aqueous solution.

25. The method according to claim 11, wherein the solution comprises between 10 g/l and 150 g/l of the potassium dichromate.

26. The method according to claim 11, further comprising:
removing a preservative from the component prior to the immersion step, if the component; and/or
degreasing the component prior to the immersion step; and/or
cleaning the component prior to the immersion step.

27. The method according to claim 11, wherein the component is only partially immersed into the solution, and
the method further comprises:
moving the partially-immersed component in the solution such that at least a portion of the blued layer is treated by the solution, which portion would not be treated without the moving.

28. The method according to claim 11, wherein the component comprises steel.

29. The method according to claim 28, wherein the component comprises rolling-element bearing steel.

30. A component comprising a material containing iron and having a blued layer formed on an outer surface thereof, wherein the blued layer lies at least partially open and has no oiling, and wherein the blued layer comprises residues of a potassium dichromate solution and/or reaction products of a potassium dichromate solution with the material or the blued layer of the component.
